(19) United States
(12) Patent Application Publication
(10) Pub. No.: US 2015/0121101 A1
(43) Pub. Date: Apr. 30, 2015

(54) POWER SUPPLY APPARATUS

(71) Applicant: SAMSUNG ELECTRO-MECHANICS CO., LTD., Suwon-Si (KR)

(72) Inventors: Jae Kuk KIM, Chungcheongnam-do (KR); Chong Eun KIM, Chungcheongnam-do (KR)

(21) Appl. No.: 14/528,839

(22) Filed: Oct. 30, 2014

(30) Foreign Application Priority Data
Oct. 31, 2013 (KR) 10-2013-0131196

(51) Int. Cl. G06F 1/26; G06F 1/32

(52) U.S. Cl. CPC G06F 1/266; G06F 1/3287
USPC 713/320

(57) ABSTRACT

A power supply apparatus includes a master circuit part charging a snubber capacitor initially and supplying power to a load under a light load; and a slave circuit part having a common output terminal with the master circuit part and supplying power to the load under a heavy load along with the master circuit part by distributing the load between them, wherein each of the master circuit part and the slave circuit part has the respective snubber capacitor that is chargeable and dischargeable at a secondary side of a transformer thereof. By doing so, power loss in a system can be reduced and efficiency under a light load improved.

### CROSS REFERENCE(S) TO RELATED APPLICATIONS

This application claims the foreign priority benefit under 35 U.S.C. Section 119 of Korean Patent Application Serial No. 10-2013-0131196, entitled “Power Supply Apparatus” filed on Oct. 31, 2013, which is hereby incorporated by reference in its entirety into this application.

### BACKGROUND

1. Technical Field

The present disclosure relates to a power supply apparatus to supply power to a server of a PC and the like, and more particularly, to a power supply apparatus capable of reducing power loss and improving efficiency under a light load.

2. Description of the Related Art

As energy consumption becomes a social issue, more attention is paid to energy conversion efficiency. In particular, energy efficiency is especially important for server power and thus it is necessary to consider server power technology, a factor significant for entry into the server market. For example, in the case of CSCI-titanium, for a load of 10%-20%-50%-100%, a high efficiency of 90%-94%-96%-91% is required. Among others, as efficiency under a light load and under an ultra-light load becomes important, there is an increasing demand for high efficiency under a very low load of 10% or less. Incidentally, some server power supplies commonly have a redundant structure in which several power supplies are connected to a common load in order to cope with various faults. In this case, efficiency under a low load may be increased by way of performing a cold redundant control that operates a master circuit part only when load becomes smaller. In this manner, however, efficiency is limited and it is difficult to improve efficiency under a very low load.

FIG. 1 is a circuit diagram of a phase-shift full bridge (PSFB) converter for a power supply apparatus according to the related art.

The circuit shown in FIG. 1 is being widely used because it has less voltage stress and zero-voltage switching at the primary side switch and has an output inductor 101 capable of reducing conduction loss due to large load current. However, the circuit has low efficiency because of hard switching under a light or ultra-light load, and power loss is generated in many elements.

FIG. 2 is a diagram of a redundant system using the PSFB converter circuit of FIG. 1.

The system shown in FIG. 2 includes a master circuit part 210 and N slave circuit parts 220 so that the master circuit part 210 and the slave circuit parts 220 are driven under a heavy load so as to distribute the load among them while only the master circuit part 210 is driven under a light load, thereby improving overall efficiency (cold redundant control). In this system, however, low efficiency corresponding to one PSFB arises under a light load, due to hard switching, transformer core loss, and conduction loss generated throughout the system.

### SUMMARY

An object of the present disclosure is to provide a power supply apparatus capable of reducing power loss in a system and improving efficiency under a light load by providing a snubber capacitor in each of the secondary sides of a master circuit part and a slave circuit part so as to supply energy charged in the snubber capacitors under a light load.

According to an exemplary embodiment, there is provided a power supply apparatus, including a master circuit part charging a snubber capacitor initially and supplying power to a load under a light load; and a slave circuit part having a common output terminal with the master circuit part and supplying power to the load under a heavy load along with the master circuit part by distributing the load between them, wherein each of the master circuit part and the slave circuit part has the snubber capacitor that is chargeable and dischargeable at a secondary side of a transformer thereof.

The snubber capacitor at the secondary side of the transformer of the master circuit part may be connected to the snubber capacitor at the secondary side of the transformer of the slave circuit part through an internal bus.

A common connection node between two semiconductor switch elements connected in series may be connected to one terminal of the snubber capacitor at the secondary side of the transformer of the master circuit part.

A common connection node between two semiconductor switch elements connected in series may be connected to one terminal of the snubber capacitor at the secondary side of the transformer of the slave circuit part.

The master circuit part, under a light load, may be operated in such a manner that only the secondary side circuit of the master circuit part with respect to the transformer of the master circuit part is operated according to a control command from an external control unit, such that power is supplied to the load by operation of an interleaved buck converter using energy charged in the snubber capacitor at the secondary side circuit.

The slave circuit part, if a voltage level of the snubber capacitor of the master circuit part is below a predetermined voltage level as it is discharged, may be driven according to a control command from an external control unit, such that power is supplied for charging the snubber capacitor of the master circuit part by an operation of an interleaved boost converter.

### BRIEF DESCRIPTION OF THE DRAWINGS

FIG. 1 is a diagram of a phase-shift full bridge (PSFB) converter for a power supply apparatus according to the related art;

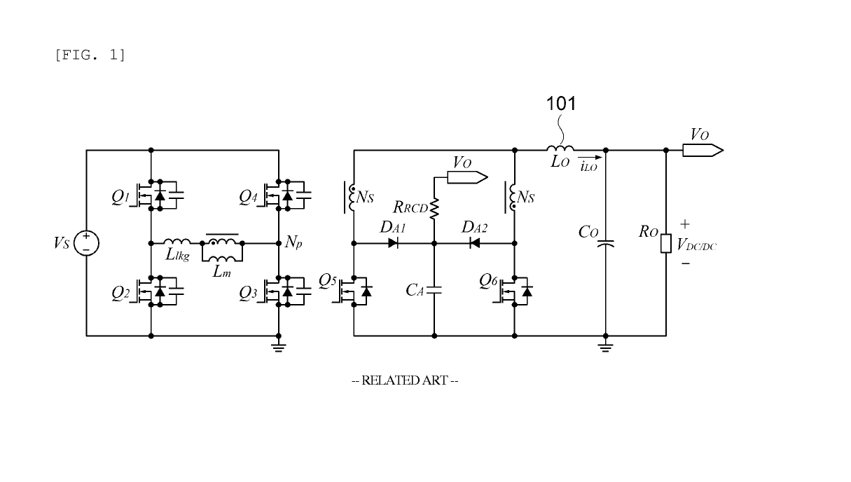

FIG. 2 is a diagram of a redundant system using the PSFB converter circuit of FIG. 1;

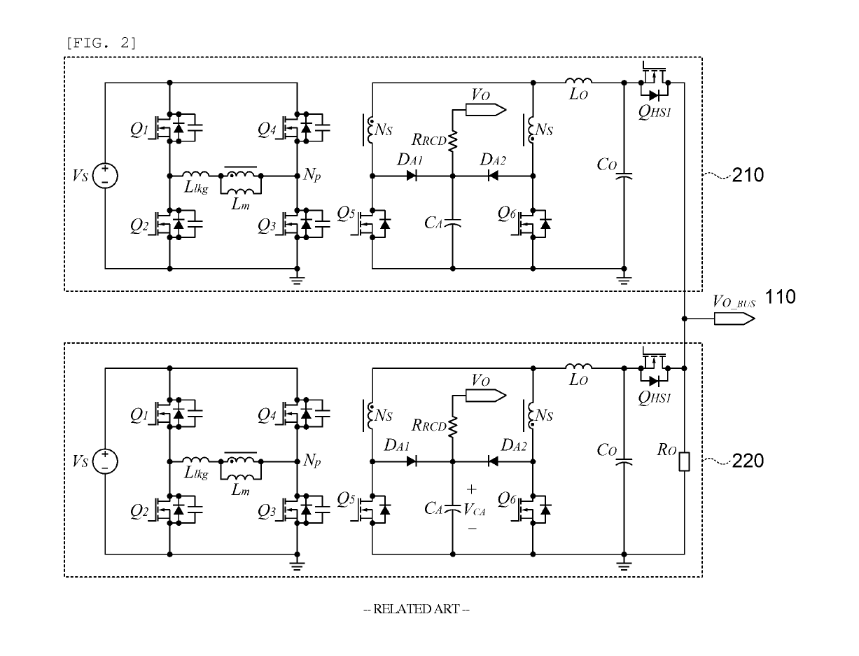

FIG. 3 is a circuit diagram of a power supply apparatus according to an exemplary embodiment of the present disclosure;

FIG. 4 is a circuit diagram of a power supply apparatus according to an exemplary embodiment operated under a light load; and

FIG. 5 is a circuit diagram of the power supply apparatus that is operated using the slave circuit part to charge the snubber capacitor at the secondary side of the master circuit part.

### DESCRIPTION OF THE PREFERRED EMBODIMENTS

Terms and words used in the present specification and claims are not to be construed as a general or dictionary meaning, but are to be construed as meaning and concepts meeting the technical ideas of the present teaching based on a principle that the inventors can appropriately define the concepts of terms in order to describe their own inventions in the best mode.

Throughout the present specification, unless explicitly stated otherwise, “comprising” any components will be understood to imply the inclusion of other elements rather than the exclusion of any other elements. The terms “part,” “module,” “device” or the like used in the specification means a unit of processing at least one function or operation and may be implemented by hardware or software or a combination of hardware and software.

Hereinafter, exemplary embodiments of the present teachings will be described in detail with reference to the accompanying drawings.

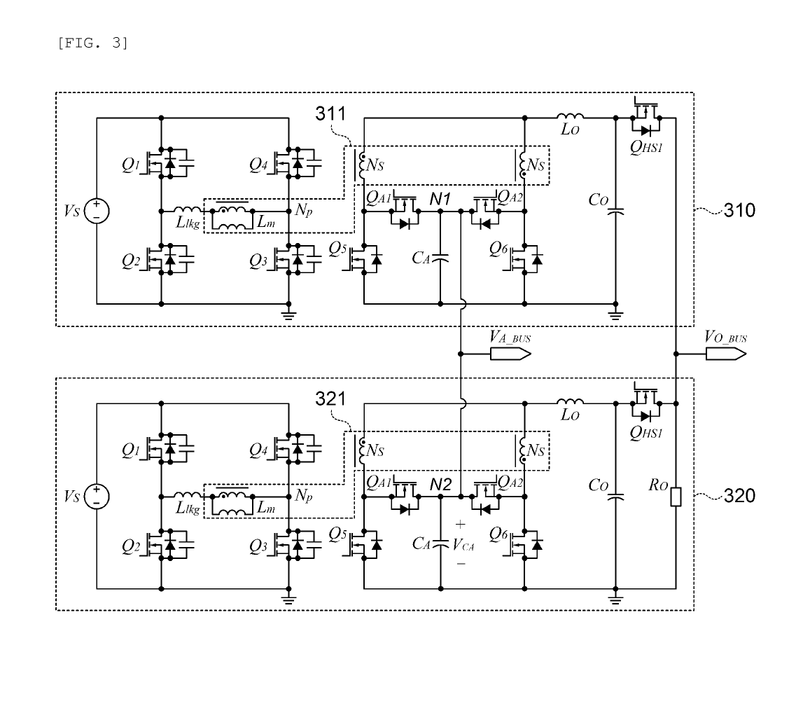

FIG. 3 is a circuit diagram of a power supply apparatus according to an exemplary embodiment.

Referring to FIG. 3, the power supply apparatus according to the exemplary embodiment includes a master circuit part 310 and a slave circuit part 320.

The master circuit part 310 initially charges a snubber capacitor C_{A} at the secondary side of a transformer 311 and supplies power to a load under a light load.

The slave circuit part 320 has a common output terminal with the master circuit part 310 and supplies power to the load when the load is heavy along with the master circuit part 310 by distributing the load among them.

According to the exemplary embodiment, a snubber capacitor C_{A} that is chargeable and dischargeable is provided at the second side N_{S} of each of the transformers 311 of the master circuit part 310 and the transformer 321 of the slave circuit part 320.

As shown, the snubber capacitors C_{A} provided at the second side N_{S} of each of the transformers 311 of the master circuit part 310 and the transformer 321 of the slave circuit part 320 may be connected to each other by an internal bus VA_BUS.

In addition, to one terminal of the snubber capacitor C_{A} provided at the second side N_{S} of the transformers 311 of the master circuit part 310, a common connection node N1 between two semiconductor switch elements Q_{A1} and Q_{A2} connected in series may be connected.

Likewise, to one terminal of the snubber capacitor C_{A} provided at the second side N_{S} of the transformers 321 of the slave circuit part 320, a common connection node N2 between two semiconductor switch elements Q_{A1} and Q_{A2} connected in series may be connected.

In addition, under a light load, only the secondary side circuit of the master circuit part 310 with respect to the transformer 311 of the master circuit part 310 is operated according to a control command from an external control unit (not shown), such that power may be supplied to a load by the operation of an interleaved buck converter using the energy charged in the snubber capacitor C_{A} provided at the secondary side circuit.

Further, if the voltage level of the snubber capacitor C_{A} of the master circuit part 310 is below a predetermined voltage level as it is discharged, the slave circuit part 320 is driven according to a control command from an external control unit (not shown), such that power is supplied for charging the snubber capacitor C_{A} of the master circuit part 310 by the operation of an interleaved boost converter.

Hereinafter, the operation of the power supply apparatus thus configured according to an exemplary embodiment will be described.

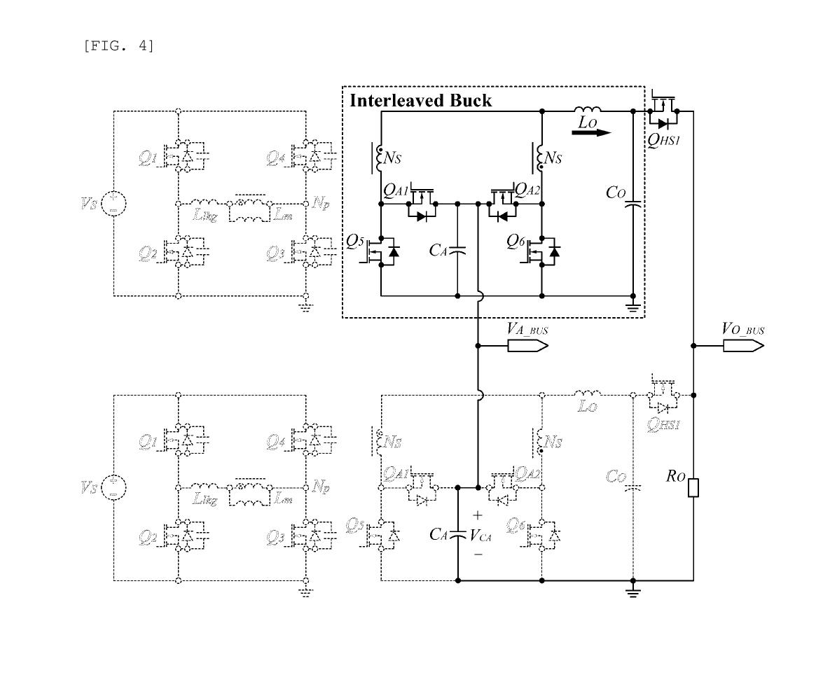

FIG. 4 is a circuit diagram of a power supply apparatus according to an exemplary embodiment operating under a light load.

Referring to FIG. 4, in the power supply apparatus according to the exemplary embodiment, only the secondary side circuit is operated under a light load, between the primary side circuit and the second side circuit corresponding to the primary winding Nₚ and the secondary winding Nₛ of the transformer 311 of the master circuit part 310, respectively. That is, power is supplied to a load by the operation of an interleaved buck converter using energy charged in the capacitor C_{A} provided at the secondary side of the transformer 311 of the master circuit part 310. By doing so, it is possible to significantly reduce power loss in elements in the primary side and the transformer generated in the related art, and efficiency under a light load is greatly improved because switches Q_{A1} and Q_{A2} can be zero voltage switched (ZVS).

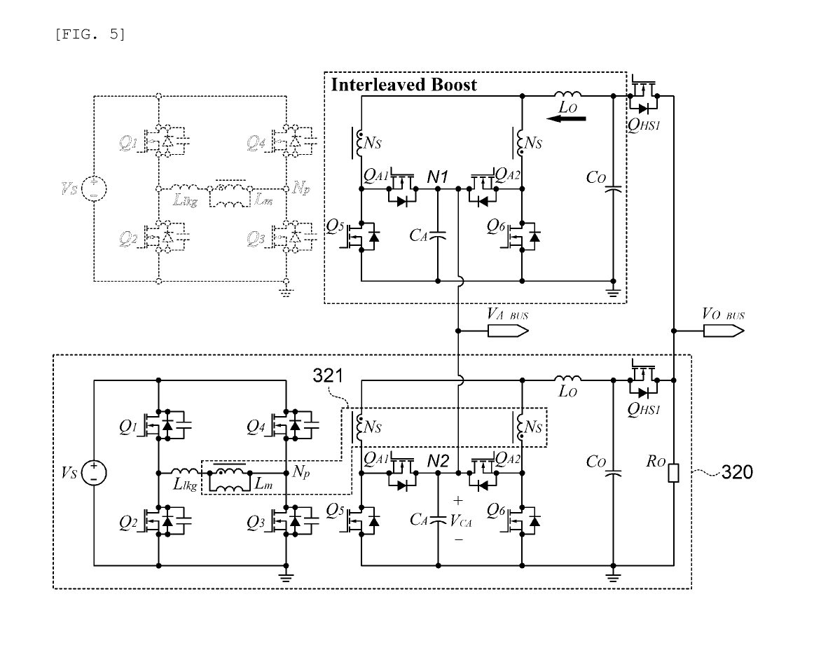

Incidentally, the snubber capacitor C_{A} at the secondary side of the master circuit part 310 needs to be charged up to an appropriate voltage level depending on the level of the discharged voltage. FIG. 5 is a circuit diagram of the power supply apparatus that is operated using the slave circuit part 320 to charge the snubber capacitor at the secondary side of the master circuit part 310. As shown in FIG. 5, if the voltage level of the capacitor C_{A} at the secondary side of the master circuit part 310 is below a predetermined level, the slave circuit part 320 is driven so that the voltage of the snubber capacitor C_{A} at the secondary side of the master circuit part 310 is charged by the operation of the interleaved boost converter. As described above, the power supply apparatus according to the present teachings performs charging using the slave circuit part therein without introducing an additional device or circuit, thereby efficiently performing charging.

As described above, the power supply apparatus according to the present teachings has a snubber capacitor that is chargeable and dischargeable in each of the master circuit part and the slave circuit part, generates bus voltage using the snubber capacitor between the modules connected in parallel in the master and slave circuit parts, and drives the secondary side circuit using only the operation of the interleaved buck converter under a light load, thereby improving system efficiency under a light load.

As set forth above, according to exemplary embodiments, power loss in a system can be reduced and efficiency under a light load can be improved by way of providing snubber capacitors that are capable of being charged and discharged in a master circuit part and a slave circuit part so as to use energy charged in the snubber capacitors to supply power under a light load.

Although the exemplary embodiments have been disclosed for illustrative purposes, the present invention is not limited thereto, but those skilled in the art will appreciate that various modifications, additions and substitutions are possible, without departing from the scope and spirit of the invention as disclosed in the accompanying claims. Therefore, the true scope of the present invention to be protected should be defined only by the appended claims and it is apparent to those skilled in the art that technical ideas equivalent thereto are within the scope of the present invention.

What is claimed is:

1. A power supply apparatus, comprising:
a master circuit part charging a snubber capacitor initially and supplying power to a load under a light load; and
a slave circuit part having a common output terminal with the master circuit part and supplying power to the load when the load is heavy along with the master circuit part by distributing the load between them,
wherein each of the master circuit part and the slave circuit part has the snubber capacitor that is chargeable and dischargeable at a secondary side of a transformer thereof.

2. The power supply apparatus according to claim 1, wherein the snubber capacitor at the secondary side of the transformer of the master circuit part is connected to the snubber capacitor at the secondary side of the transformer of the slave circuit part through an internal bus.

3. The power supply apparatus according to claim 1, wherein a common connection node between two semiconductor switch elements connected in series is connected to one terminal of the snubber capacitor at the secondary side of the transformer of the master circuit part.

4. The power supply apparatus according to claim 1, wherein a common connection node between two semiconductor switch elements connected in series is connected to one terminal of the snubber capacitor at the secondary side of the transformer of the slave circuit part.

5. The power supply apparatus according to claim 1, wherein the master circuit part, under a light load, is operated in such a manner that only the secondary side circuit of the master circuit part with respect to the transformer of the master circuit part is operated according to a control command from an external control unit, such that power is supplied to the load by an operation of an interleaved buck converter using energy charged in the snubber capacitor at the secondary side circuit.

6. The power supply apparatus according to claim 1, wherein the slave circuit part, if a voltage level of the snubber capacitor of the master circuit part is below a predetermined voltage level as it is discharged, is driven according to a control command from an external control unit, such that power is supplied for charging the snubber capacitor of the master circuit part by an operation of an interleaved boost converter.
